(19) United States
(12) Patent Application Publication
(10) Pub. No.: US 2025/0167980 A1
(43) Pub. Date: May 22, 2025

(54) DATA PROCESSING METHODS AND SYSTEMS FOR ENCRYPTED DATABASE

(71) Applicant: Alipay (Hangzhou) Information Technology Co., Ltd., Hangzhou (CN)

(72) Inventors: Yixuan Song, Hangzhou (CN); Yinchao Zou, Hangzhou (CN)

(21) Appl. No.: 18/947,659

(22) Filed: Nov. 14, 2024

(30) Foreign Application Priority Data
Nov. 16, 2023 (CN) 202311533893.1

(51) Int. Cl. H04L 9/06; G06F 21/62

(52) U.S. Cl. CPC H04L 9/0618; G06F 21/6218

(57) ABSTRACT

A data processing method for an encrypted database is performed by a heterogeneous processing platform including a first computing unit implemented by a general processing unit and a second computing unit implemented by a dedicated acceleration unit. The method includes: obtaining, by the first computing unit, a ciphertext parameter and a database instruction from a user end device, where the database instruction instructs to perform a target operation on the encrypted database; converting the database instruction into a computing instruction to be executed by the second computing unit, and transmitting the computing instruction to the second computing unit; performing, by the second computing unit according to the computing instruction, a cryptographic operation corresponding to the target operation on ciphertext data in the encrypted database and the ciphertext parameter, to obtain a ciphertext result; and transmitting, by the second computing unit, the ciphertext result to the first computing unit.

### CROSS-REFERENCE TO RELATED APPLICATIONS

The present application is based upon and claims priority to Chinese Patent Application No. 202311533893.1, filed on Nov. 16, 2023, the content of which is incorporated herein by reference in its entirety.

### TECHNICAL FIELD

Embodiments of this specification relate to the computer field, and in particular, to data processing methods and systems for an encrypted database.

### BACKGROUND

In the privacy computing field, a database is one piece of important basic software. For key software technologies in privacy computing products, performance needs to be improved.

As an important part of the basic software, the database has important value in the privacy computing field. The encrypted database implements security protection on data based on a cryptographic algorithm, and computing overheads and computing time are generally very high. In conventional technologies, during data processing for the encrypted database, due to the limitation by computing overheads of a cryptographic operation, performance of the encrypted database may be relatively low.

### SUMMARY

Embodiments of this specification provide data processing methods and systems for an encrypted database, to improve performance of the encrypted database.

According to a first aspect, a data processing method for an encrypted database is provided. The method is performed by a heterogeneous processing platform including a first computing unit implemented by a general processing unit and a second computing unit implemented by a dedicated acceleration unit, and the method includes: obtaining, by the first computing unit, a ciphertext parameter and a database instruction from a user end device, wherein the database instruction instructs to perform a target operation on the encrypted database; converting, by the first computing unit, the database instruction into a computing instruction to be executed by the second computing unit, and transmitting the computing instruction to the second computing unit; performing, by the second computing unit according to the computing instruction, a cryptographic operation corresponding to the target operation on ciphertext data in the encrypted database and the ciphertext parameter, to obtain a ciphertext result; and transmitting, by the second computing unit, the ciphertext result to the first computing unit.

According to a second aspect, a data processing system for an encrypted database is provided. The system includes at least one processor; and at least one memory storing instructions executable by the at least one processor. The at least one processor includes a first computing unit implemented by a general processing unit and a second computing unit implemented by a dedicated acceleration unit, and is configured to: obtain, the first computing unit, a ciphertext parameter and a database instruction from a user end device, wherein the database instruction instructs to perform a target operation on the encrypted database; convert, by the first computing unit, the database instruction into a computing instruction to be executed by the second computing unit, and transmit the computing instruction to the second computing unit; perform, by the second computing unit according to the computing instruction, a cryptographic operation corresponding to the target operation on ciphertext data in the encrypted database and the ciphertext parameter, to obtain a ciphertext result; and transmit the ciphertext result to the first computing unit.

### BRIEF DESCRIPTION OF DRAWINGS

The following briefly describes the accompanying drawings for describing the embodiments. The accompanying drawings in the following descriptions illustrate merely example embodiments of this disclosure.

FIG. 1 is a schematic diagram illustrating an implementation scenario of a data processing method for an encrypted database, according to an embodiment.

FIG. 2 is a schematic diagram illustrating an implementation scenario of a data processing method for an encrypted database, according to an embodiment.

FIG. 3 is a schematic diagram illustrating an implementation scenario of a data processing method for an encrypted database, according to an embodiment.

FIG. 4 is a flowchart illustrating a data processing method for an encrypted database, according to an embodiment.

FIG. 5 is a schematic block diagram illustrating a data processing system for an encrypted database, according to an embodiment.

FIG. 6 is a schematic block diagram illustrating a data processing system for an encrypted database, according to an embodiment.

### DETAILED DESCRIPTION OF EMBODIMENTS

Reference will now be made in detail to embodiments, examples of which are illustrated in the accompanying drawings. The following description refers to the accompanying drawings in which the same numbers in different drawings represent the same or similar elements unless otherwise represented. The described embodiments are merely examples of rather than all the embodiments of the present disclosure.

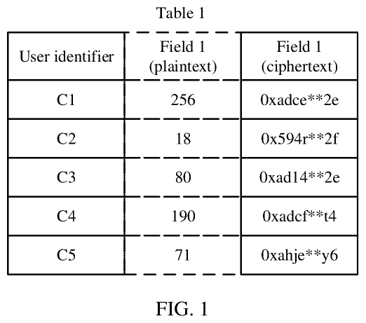

FIG. 1 is a schematic diagram illustrating an implementation scenario of a data processing method for an encrypted database, according to an embodiment. A storage form of data in the encrypted database is described here. The encrypted database is a database system that manages and stores encrypted data. The data are stored in the database in a ciphertext form. Database operations such as data storage and computing are completed in a ciphertext form. For example, the encrypted database includes a plurality of data tables, and each data table includes a plurality of fields. The fields correspond to columns, each column includes a plurality of field values, the field values are usually private data, plaintexts of the field values cannot be disclosed, and only ciphertexts of the field values are stored in the encrypted database.

As shown in FIG. 1, Table 1 is a data table in the encrypted database, a field 1 included in Table 1 is private data, and a column corresponding to the field 1 stores a ciphertext of a field value. For example, a ciphertext of a field value that is of the field 1 and that corresponds to a user identifier C1 is 0xadc**2e, and a plaintext corresponding to the ciphertext is 256; a ciphertext of a field value that is of the field 1 and that corresponds to a user identifier C2 is 0x594r**2f, and a plaintext corresponding to the ciphertext is 18; a ciphertext of a field value that is of the field 1 and that corresponds to a user identifier C3 is 0xad14**2e, and a plaintext corresponding to the ciphertext is 80; a ciphertext of a field value that is of the field 1 and that corresponds to a user identifier C4 is 0xadcf**t4, and a plaintext corresponding to the ciphertext is 190; and a ciphertext of a field value that is of the field 1 and that corresponds to a user identifier C5 is 0xahje*y6, and a plaintext corresponding to the ciphertext is 71. In FIG. 1, for illustration purposes only, not only a column corresponding to the plaintexts of the field 1 is given, but also a column corresponding to the ciphertexts of the field 1 is given. This is merely for ease of comparison between the plaintext and the ciphertext. In reality, the encrypted database stores only the ciphertexts of all the field values of the field 1 (indicated by the solid lines in FIG. 1), but does not store the plaintexts of all the field values of the field 1 (indicated by the dashed lines in FIG. 1).

In the embodiment, the ciphertext is data obtained by encrypting the plaintext by using a key. In cryptography, a key is information used to implement cryptographic applications such as encryption, decryption, and computing.

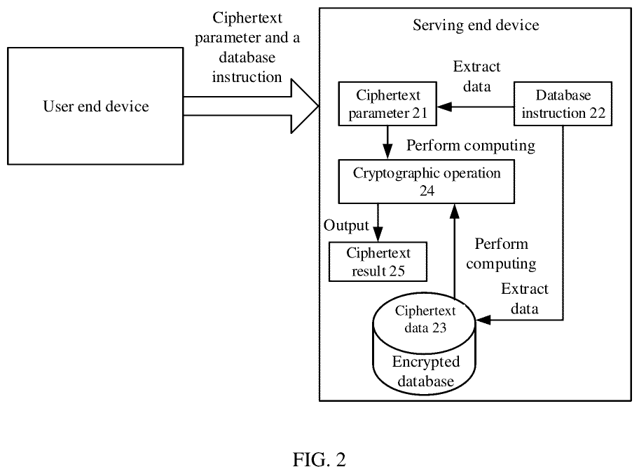

FIG. 2 is a schematic diagram illustrating an implementation scenario of a data processing method for an encrypted database, according to an embodiment. Devices used in the data processing and a common processing procedure are described here. For example, the devices include a user end device and a serving end device.

The user end device provides a user execution environment. The user execution environment is constructed by a user, and is considered to be a secure and trusted execution environment, briefly referred to as a trusted execution environment. Highly private data such as plaintext data and a private key can be used in the trusted execution environment. In cryptography, the trusted execution environment is an independent, trusted, and isolated execution environment on a device, and is used to operate private data and perform sensitive computing.

The serving end device is usually deployed remotely and may be located in an untrusted security environment, and data are transmitted and operated in a ciphertext form. As data in the ciphertext form need to be operated in a corresponding cryptographic operation, full-link data outside the user execution environment need to be in a ciphertext form, to ensure security of the private data. The encrypted database stores data in a ciphertext format, and provides database functions such as querying, computing, creating, and updating. The cryptographic operation for the encrypted database can be performed based on a fully homomorphic algorithm. The fully homomorphic algorithm is a common cryptographic encryption scheme, where any data operation can be implemented in a ciphertext state without decryption, and a result the same as that of plaintext computing is obtained.

In an embodiment, a data processing procedure for the encrypted database includes the following steps. The user end device can initialize a private key, a public key, and an auxiliary key; receive a user instruction and a user parameter of a user by using a client, where the user instruction is used to indicate a corresponding database operation, and the user parameter is a parameter required for performing the database operation; and encrypt the user parameter into a ciphertext parameter in a ciphertext format by using the public key, and optimize, by using a compiler, the user instruction into a database instruction that can be executed by the serving end device. Referring to FIG. 2, the user end device sends the ciphertext parameter 21 and the database instruction 22 to the serving end device. The serving end device analyzes the database instruction 22, and extracts corresponding ciphertext data 23 and the ciphertext parameter 21 to perform a cryptographic operation 24 by performing computing. An auxiliary key that may be required in the cryptographic operation can be directly sent by the user end device to the serving end device. After the cryptographic operation 24, a corresponding ciphertext result 25 is obtained. The ciphertext result 25 can be stored in the encrypted database, or the ciphertext result can be transmitted to the user end device. The user end device decrypts the ciphertext result by using the private key, to obtain a plaintext result.

In an embodiment, computing efficiency of the cryptographic operation can be further improved. For example, a fully homomorphic operation can support arithmetic operations such as vector rotation and addition/subtraction/multiplication/division, but computing performance of the fully homomorphic operation is several orders of magnitude lower than that of plaintext computing.

In this embodiment, a serving end device with a heterogeneous processing platform is used. The heterogeneous processing platform is a computing platform including computing units of different system architectures. The heterogeneous processing platform can include a first computing unit implemented by a general processing unit and a second computing unit implemented by a dedicated acceleration unit. In data processing for the encrypted database, the cryptographic operation is migrated from the first computing unit to the second computing unit for execution, to improve computing efficiency of the cryptographic operation, and correspondingly improve performance of the encrypted database.

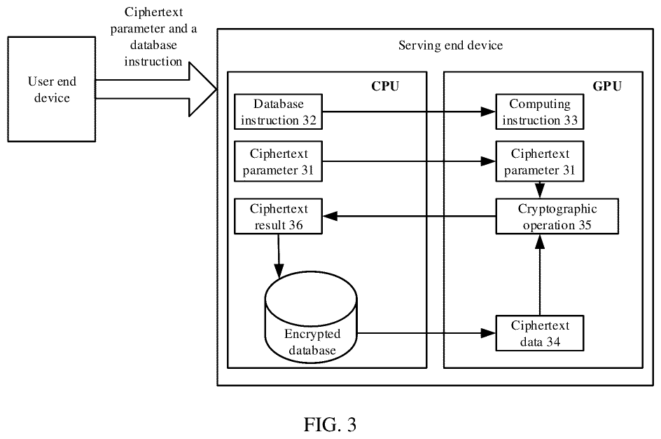

FIG. 3 is a schematic diagram illustrating an implementation scenario of a data processing method for an encrypted database, according to an embodiment. The implementation scenario is based on a serving end device with a heterogeneous processing platform. As shown in FIG. 3, the heterogeneous processing platform includes a first computing unit implemented by a general processing unit and a second computing unit implemented by a dedicated acceleration unit. The first computing unit is, for example, a central processing unit (CPU), and the second computing unit is, for example, a graphics processing unit (GPU). A data processing procedure for the encrypted database includes the following steps. The user end device can initialize a private key, a public key, and an auxiliary key; receive a user instruction and a user parameter of a user by using a client, where the user instruction is used to indicate a corresponding database operation, and the user parameter is a parameter required for performing the database operation; and encrypt the user parameter into a ciphertext parameter in a ciphertext format by using the public key, and optimize, by using a compiler, the user instruction into a database instruction that can be executed by the serving end device. Referring to FIG. 3, the user end device sends the ciphertext parameter 31 and the database instruction 32 to the serving end device. The CPU of the serving end device further converts, e.g., optimizes, the database instruction 32 to a computing instruction 33 as a GPU instruction. The GPU of the serving end device reads the ciphertext parameter 31 and ciphertext data 34 from the CPU based on the GPU instruction, and stores the ciphertext parameter 31 and the ciphertext data 34 in a graphics memory. The GPU performs a cryptographic operation 35 based on the ciphertext data 33 and the ciphertext parameter 31 in the graphics memory, to obtain a corresponding ciphertext result 36. The GPU returns the ciphertext result 36 to the CPU, and the CPU can store the ciphertext result in the encrypted database, or can transmit the ciphertext result to the user end device. The user end device decrypts the ciphertext result by using the private key, to obtain a plaintext result. Based on the GPU, in this embodiment, a speed can be 100 times higher than a speed achieved when only a physical core of the CPU is used.

It should be noted that the embodiment sets no limitation on a type of the cryptographic operation, and can also be implemented by an encrypted database architecture in which another non-fully homomorphic solution is used in the cryptographic operation. The embodiment also sets no limitation on a heterogeneous processing platform including a CPU and a GPU, and can also be implemented by another heterogeneous processing platform such as a CPU and an FPGA or a CPU and an ASIC with a cryptographic acceleration capability. The embodiment also sets no limitation on a heterogeneous processing platform on which hardware is separated, and can also be implemented by a system on chip (SoC) system in which a CPU and a GPU are integrated together.

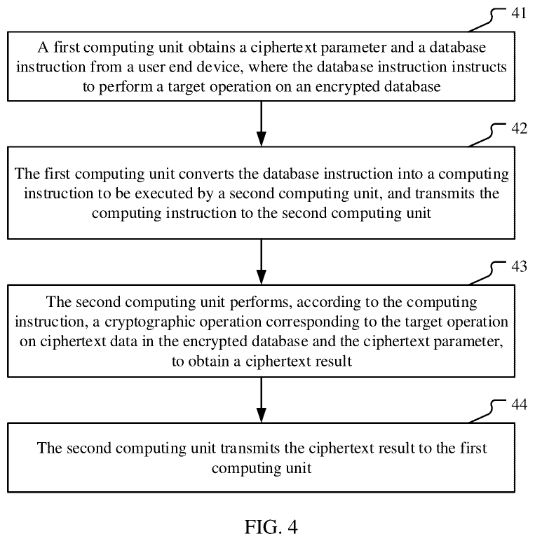

FIG. 4 is a flowchart illustrating a data processing method for an encrypted database, according to an embodiment. The method is performed by a heterogeneous processing platform including a first computing unit implemented by a general processing unit and a second computing unit implemented by a dedicated acceleration unit, and the method can be based on the implementation scenario shown in FIG. 1, FIG. 2, or FIG. 3. As shown in FIG. 4, the data processing method includes the following steps: Step 41: The first computing unit obtains a ciphertext parameter and a database instruction from a user end device, where the database instruction instructs to perform a target operation on the encrypted database. Step 42: The first computing unit converts the database instruction into a computing instruction to be executed by the second computing unit, and transmits the computing instruction to the second computing unit. Step 43: The second computing unit performs, according to the computing instruction, a cryptographic operation corresponding to the target operation on ciphertext data in the encrypted database and the ciphertext parameter, to obtain a ciphertext result. Step 44: The second computing unit transmits the ciphertext result to the first computing unit. The following describes a specific execution manner of the above-mentioned steps.

First, in step 41, the first computing unit obtains the ciphertext parameter and the database instruction from the user end device. The database instruction instructs to perform a target operation on the encrypted database. The database instruction can be an instruction compiled by the user end device, and the instruction can be understood by the first computing unit.

The target operation can include a corresponding cryptographic operation and an operation on data.

In this embodiment, the first computing unit and the second computing unit form the heterogeneous processing platform, and the first computing unit and the second computing unit may each correspond to one or more of a plurality of different system architectures.

In an example, the first computing unit is a central processing unit (CPU), and the second computing unit is at least one of a graphics processing unit (GPU), a field programmable gate array (FPGA), or an application-specific integrated circuit (ASIC).

In this example, the heterogeneous processing platform can be a combination of a CPU and a GPU, or a combination of a CPU and an FPGA, or a combination of a CPU and an ASIC, and these heterogeneous processing platforms are applicable to the data processing method provided in this embodiment of this specification.

In an example, the user end device has a public key and a corresponding private key, and the ciphertext parameter is obtained after the user parameter is encrypted by using the public key.

The user parameter is a parameter involved in the target operation, and the ciphertext parameter is applied to the cryptographic operation corresponding to the target operation. For example, a user wants to perform an operation of 3*x+y, that is, an operation of a multiplication operation and an addition operation. Here, x and y are data in the database. The target operation instructed by the database instruction is 3*x+y, and an involved user parameter is 3. The target operation can be decomposed into the following plurality of suboperations: fetching a ciphertext x from the database and transmitting the ciphertext x to the second computing unit; fetching a ciphertext y and transmitting the ciphertext y to the second computing unit; transmitting a ciphertext of data 3 to the second computing unit; and performing the cryptographic operation 3*x+y in a ciphertext form in the second computing unit.

For another example, a user wants to perform an operation of x², that is, an operation of an exponentiation operation. Here, x is data in the database. The target operation instructed by the database instruction is x², and an involved user parameter is 2. The target operation can be decomposed into the following plurality of suboperations: fetching a ciphertext x from the database and transmitting the ciphertext x to the second computing unit; fetching a ciphertext of data 2 and transmitting the ciphertext of the data 2 to the second computing unit; and performing the cryptographic operation x² in a ciphertext form in the second computing unit.

For another example, a user wants to perform an operation of (x1+x2+ . . . x10)/10, that is, an operation of obtaining an average value. Here, x1, x2, . . . , and x10 are data in the database. The target operation instructed by the database instruction is (x1+x2+ . . . x10)/10, and an involved user parameter is 10. The target operation can be decomposed into the following plurality of suboperations: fetching a ciphertext x1 from the database and transmitting the ciphertext x1 to the second computing unit; fetching a ciphertext x2 from the database and transmitting the ciphertext x2 to the second computing unit; . . . ; fetching a ciphertext x10 from the database and transmitting the ciphertext x10 to the second computing unit; transmitting a ciphertext of data 10 to the second computing unit; and performing the cryptographic operation (x1+x2+ . . . x10)/10 in a ciphertext form in the second computing unit. Then, in step 42, the first computing unit converts the database instruction into the computing instruction that needs to be executed by the second computing unit, and transmits the computing instruction to the second computing unit. It can be understood that the first computing unit and the second computing unit usually use different instruction sets, and the first computing unit needs to complete instruction conversion.

In the above example, the target operation is 3*x+y, and the computing instruction is used to instruct the second computing unit to perform the cryptographic operation 3*x+y in a ciphertext form. The second computing unit performs the following suboperations according to the computing instruction: computing ciphertext multiplication of 3*x by using a cryptographic operation, and computing ciphertext addition of 3*x+y.

Next, in step 43, the second computing unit performs, according to the computing instruction, the cryptographic operation corresponding to the target operation on the ciphertext data in the encrypted database and the ciphertext parameter, to obtain the ciphertext result. The first computing unit can read the ciphertext data from the encrypted database, and then transmit the ciphertext data to the second computing unit; or the second computing unit directly reads the ciphertext data from the encrypted database.

In an example, before the second computing unit performs, according to the computing instruction, the cryptographic operation corresponding to the target operation on the ciphertext data in the encrypted database and the ciphertext parameter, the method further includes: the first computing unit reads the ciphertext data from the encrypted database based on the database instruction, and transmits the ciphertext data and the ciphertext parameter to the second computing unit.

In this example, the first computing unit reads the ciphertext data from the encrypted database, and then transmits the ciphertext data to the second computing unit.

In another example, before the second computing unit performs, according to the computing instruction, the cryptographic operation corresponding to the target operation on the ciphertext data in the encrypted database and the ciphertext parameter, the method further includes: the first computing unit transmits a read instruction determined based on the database instruction to the second computing unit; and the second computing unit reads the ciphertext data from the encrypted database according to the read instruction.

In this example, the second computing unit directly reads the ciphertext data from the encrypted database.

In an example, the encrypted database is a homomorphically encrypted database, and the cryptographic operation is a homomorphic operation.

In this example, homomorphic encryption is an encryption mode in cryptography, and is an encryption algorithm that satisfies a ciphertext homomorphic operation property. For example, after homomorphic encryption is performed on data, specific computing is performed on a ciphertext, to obtain a ciphertext computing result. After corresponding homomorphic decryption is performed, a plaintext is obtained, and the plaintext is equivalent to directly performing the same computing on the plaintext data.

In an example, the user end device has the public key and the corresponding private key, the ciphertext parameter is obtained after the user parameter is encrypted by using the public key, and the private key is used to decrypt the ciphertext result.

In an embodiment, the method further includes: the first computing unit obtains an auxiliary key from the user end device, and transmits the auxiliary key to the second computing unit; and the second computing unit performs the cryptographic operation based on the auxiliary key.

The second computing unit is a graphics processing unit (GPU) or an AI accelerator chip that is applicable for a matrix operation, the cryptographic operation includes a fully homomorphic encryption operation implemented based on a fast number-theoretic transform (NTT), and the NTT is implemented by using the matrix operation.

In an example, the first computing unit is a central processing unit (CPU), and the second computing unit is a graphics processing unit (GPU); and that the second computing unit performs, according to the computing instruction, a cryptographic operation corresponding to the target operation on ciphertext data in the encrypted database and the ciphertext parameter includes: the second computing unit stores the ciphertext data and the ciphertext parameter in a graphics memory based on the computing instruction; and the second computing unit reads the ciphertext data and the ciphertext parameter from the graphics memory, to perform the cryptographic operation to obtain the ciphertext result.

Next, in step 44, the second computing unit transmits the ciphertext result to the first computing unit. After the ciphertext result is obtained, subsequent processing can be performed by the first computing unit.

In an example, after the second computing unit transmits the ciphertext result to the first computing unit, the method further includes: the first computing unit stores the ciphertext result in the encrypted database; or the first computing unit sends the ciphertext result to the user end device.

In this example, after obtaining the ciphertext result, the user end device can decrypt the ciphertext result by using the private key held by the user end device, to obtain a plaintext result.

In an example, the first computing unit is a central processing unit (CPU), and the second computing unit is a graphics processing unit (GPU); and that the second computing unit performs, according to the computing instruction, a cryptographic operation corresponding to the target operation on ciphertext data in the encrypted database and the ciphertext parameter includes: the second computing unit stores the ciphertext data and the ciphertext parameter in a graphics memory based on the computing instruction; and the second computing unit reads the ciphertext data and the ciphertext parameter from the graphics memory, to perform the cryptographic operation to obtain the ciphertext result.

The method provided in this embodiment is performed by the heterogeneous processing platform including a first computing unit implemented by a general processing unit and a second computing unit implemented by a dedicated acceleration unit. First, the first computing unit obtains a ciphertext parameter and a database instruction from a user end device. The database instruction instructs to perform a target operation on the encrypted database. Then, the first computing unit converts the database instruction into a computing instruction that needs to be executed by the second computing unit, and transmits the computing instruction to the second computing unit. Next, the second computing unit performs, according to the computing instruction, a cryptographic operation corresponding to the target operation on ciphertext data in the encrypted database and the ciphertext parameter, to obtain a ciphertext result. Next, the second computing unit transmits the ciphertext result to the first computing unit. In the embodiments of this specification, the first computing unit receives the database instruction from the user end device and converts the instruction, and sends a converted instruction to the second computing unit. The second computing unit performs the cryptographic operation based on the converted instruction. In this manner, a software/hardware technology based on the heterogeneous computing platform is used, to effectively improve performance of performing the cryptographic operation in the target operation on the cryptography database, and further improve performance of the cryptography database.

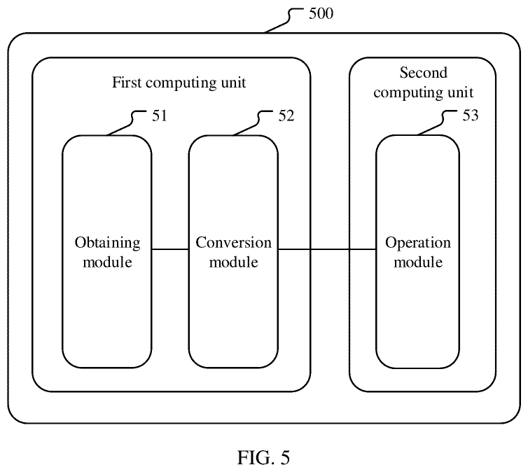

Embodiments of this specification also provide a data processing system for an encrypted database. The system uses a heterogeneous processing platform including a first computing unit implemented by a general processing unit and a second computing unit implemented by a dedicated acceleration unit, and the system is configured to perform the method described above. FIG. 5 is a schematic block diagram illustrating a data processing system 500 for an encrypted database, according to an embodiment. As shown in FIG. 5, the system 500 includes: an obtaining module 51, disposed in the first computing unit, and configured to obtain a ciphertext parameter and a database instruction from a user end device, where the database instruction instructs to perform a target operation on the encrypted database; a conversion module 52, disposed in the first computing unit, and configured to: convert the database instruction obtained by the obtaining module 51 into a computing instruction that needs to be executed by the second computing unit, and transmit the computing instruction to the second computing unit; and an operation module 53, disposed in the second computing unit, and configured to: perform, according to the computing instruction, a cryptographic operation corresponding to the target operation on ciphertext data in the encrypted database and the ciphertext parameter, to obtain a ciphertext result; and transmit the ciphertext result to the first computing unit.

In an embodiment, the system further includes: a reading module, disposed in the first computing unit, and configured to: before the operation module 53 performs, according to the computing instruction, the cryptographic operation corresponding to the target operation on the ciphertext data in the encrypted database and the ciphertext parameter, read the ciphertext data from the encrypted database based on the database instruction, and transmit the ciphertext data and the ciphertext parameter to the second computing unit.

In an embodiment, the system further includes: an indication module, disposed in the first computing unit, and configured to: before the operation module 53 performs, according to the computing instruction, the cryptographic operation corresponding to the target operation on the ciphertext data in the encrypted database and the ciphertext parameter, transmit a read instruction determined based on the database instruction to the second computing unit; and a reading module, disposed in the second computing unit, and configured to read the ciphertext data from the encrypted database according to the read instruction.

In an embodiment, the system further includes: a storage module, disposed in the first computing unit, and configured to store the ciphertext result in the encrypted database after the second computing unit transmits the ciphertext result to the first computing unit; or a sending module, disposed in the first computing unit, and configured to send the ciphertext result to the user end device after the second computing unit transmits the ciphertext result to the first computing unit.

In an embodiment, the first computing unit is a central processing unit (CPU), and the second computing unit is at least one of a graphics processing unit (GPU), a field programmable gate array (FPGA), or an application-specific integrated circuit (ASIC).

In an embodiment, the encrypted database is a homomorphically encrypted database, and the cryptographic operation is a homomorphic operation.

In an embodiment, the user end device has a public key and a corresponding private key, the ciphertext parameter is obtained after a user parameter is encrypted by using the public key, and the private key is used to decrypt the ciphertext result.

In an embodiment, the system further includes: a transmission module, disposed in the first computing unit, and configured to: obtain an auxiliary key from the user end device, and transmit the auxiliary key to the second computing unit.

The operation module 53 performs the cryptographic operation based on the auxiliary key.

In an embodiment, the second computing unit is a graphics processing unit (GPU) or an AI accelerator chip that is applicable for a matrix operation, the cryptographic operation includes a fully homomorphic encryption operation implemented based on a fast number-theoretic transform (NTT), and the NTT is implemented by using the matrix operation.

In an embodiment, the first computing unit is a central processing unit (CPU), and the second computing unit is a graphics processing unit (GPU).

The operation module 53 is further configured to: store the ciphertext data and the ciphertext parameter in a graphics memory based on the computing instruction; and read the ciphertext data and the ciphertext parameter from the graphics memory, to perform the cryptographic operation to obtain the ciphertext result.

The system provided in the embodiment uses the heterogeneous processing platform including a first computing unit implemented by a general processing unit and a second computing unit implemented by a dedicated acceleration unit. First, the obtaining module 51 disposed in the first computing unit obtains a ciphertext parameter and a database instruction from a user end device. The database instruction instructs to perform a target operation on the encrypted database. Then, the conversion module 52 disposed in the first computing unit converts the database instruction into a computing instruction that needs to be executed by the second computing unit, and transmits the computing instruction to the second computing unit. Next, the operation module 53 disposed in the second computing unit performs, according to the computing instruction, a cryptographic operation corresponding to the target operation on ciphertext data in the encrypted database and the ciphertext parameter, to obtain a ciphertext result. The ciphertext result is transmitted to the first computing unit.

In the embodiment, the first computing unit receives the database instruction from the user end device and converts the instruction, and sends a converted instruction to the second computing unit. The second computing unit performs the cryptographic operation based on the converted instruction. In this manner, a software/hardware technology based on the heterogeneous computing platform is used, to effectively improve performance of performing the cryptographic operation in the target operation on the cryptography database, and further improve performance of the cryptography database.

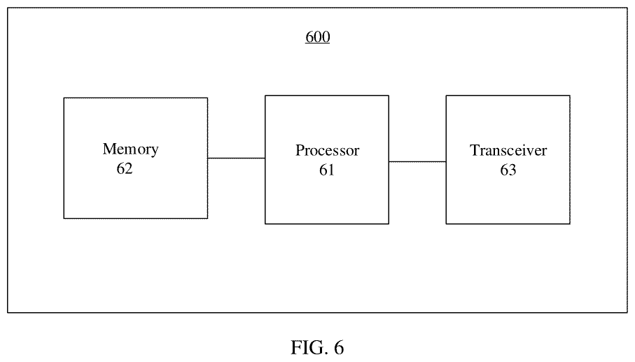

FIG. 6 is a schematic block diagram illustrating a data processing system 600 for an encrypted database, according to an embodiment. As shown in FIG. 6, the system 600 includes: at least one processor 61; and at least one memory 62 storing instructions executable by the at least one processor 61. The at least one processor 61 includes a first computing unit implemented by a general processing unit and a second computing unit implemented by a dedicated acceleration unit, and is configured to: obtain, the first computing unit, a ciphertext parameter and a database instruction from a user end device, wherein the database instruction instructs to perform a target operation on the encrypted database; convert, by the first computing unit, the database instruction into a computing instruction to be executed by the second computing unit, and transmit the computing instruction to the second computing unit; perform, by the second computing unit according to the computing instruction, a cryptographic operation corresponding to the target operation on ciphertext data in the encrypted database and the ciphertext parameter, to obtain a ciphertext result; and transmit the ciphertext result to the first computing unit. The system 600 may further include a transceiver 63 for communicating with another device, such as the user end device.

In an embodiment, before performing, by the second computing unit according to the computing instruction, the cryptographic operation corresponding to the target operation on ciphertext data in the encrypted database and the ciphertext parameter, the at least one processor 61 is further configured to: read, by the first computing unit, the ciphertext data from the encrypted database based on the database instruction, and transmit the ciphertext data and the ciphertext parameter to the second computing unit.

In an embodiment, before performing, by the second computing unit according to the computing instruction, the cryptographic operation corresponding to the target operation on the ciphertext data in the encrypted database and the ciphertext parameter, the at least one processor 61 is further configured to: transmit, by the first computing unit, a read instruction determined based on the database instruction to the second computing unit; and read, by the second computing unit, the ciphertext data from the encrypted database according to the read instruction.

In an embodiment, after transmitting, by the second computing unit, the ciphertext result to the first computing unit, the at least one processor 61 is further configured to: store, by the first computing unit, the ciphertext result in the encrypted database; or send, by the first computing unit, the ciphertext result to the user end device.

In an embodiment, the first computing unit is a central processing unit (CPU), and the second computing unit is at least one of a graphics processing unit (GPU), a field programmable gate array (FPGA), or an application-specific integrated circuit (ASIC).

In an embodiment, the encrypted database is a homomorphically encrypted database, and the cryptographic operation is a homomorphic operation.

In an embodiment, the user end device has a public key and a corresponding private key, the ciphertext parameter is obtained after a user parameter is encrypted by using the public key, and the private key is used to decrypt the ciphertext result.

In an embodiment, the at least one processor 61 is further configured to: obtain, by the first computing unit, an auxiliary key from the user end device, and transmit the auxiliary key to the second computing unit; and perform, by the second computing unit, the cryptographic operation based on the auxiliary key.

In an embodiment, the second computing unit is a graphics processing unit (GPU) or an AI accelerator chip that is applicable for a matrix operation, the cryptographic operation comprises a fully homomorphic encryption operation implemented based on a fast number-theoretic transform (NTT), and the NTT is implemented by using the matrix operation.

In an embodiment, the first computing unit is a central processing unit (CPU), and the second computing unit is a graphics processing unit (GPU); and the at least one processor 61 is further configured to: store, by the second computing unit, the ciphertext data and the ciphertext parameter in a graphics memory based on the computing instruction; and read, by the second computing unit, the ciphertext data and the ciphertext parameter from the graphics memory, to perform the cryptographic operation to obtain the ciphertext result.

Embodiments of this specification also provide a non-transitory computer-readable storage medium. The computer-readable storage medium stores a computer program, and when the computer program is executed on a computer, the computer is caused to perform the method described above.

The methods and systems provided in the embodiments of this specification are performed by the heterogeneous processing platform, and the heterogeneous processing platform includes a first computing unit implemented by a general processing unit and a second computing unit implemented by a dedicated acceleration unit. First, the first computing unit obtains a ciphertext parameter and a database instruction from a user end device. The database instruction instructs to perform a target operation on the encrypted database. Then, the first computing unit converts the database instruction into a computing instruction that needs to be executed by the second computing unit, and transmits the computing instruction to the second computing unit. Next, the second computing unit performs, according to the computing instruction, a cryptographic operation corresponding to the target operation on ciphertext data in the encrypted database and the ciphertext parameter, to obtain a ciphertext result. Next, the second computing unit transmits the ciphertext result to the first computing unit. It can be learned from the above-mentioned descriptions that in the embodiments of this specification, the first computing unit receives the database instruction from the user end device and converts the instruction, and sends a converted instruction to the second computing unit. The second computing unit performs the cryptographic operation based on the converted instruction. In this manner, a software/hardware technology based on the heterogeneous computing platform is used, to effectively improve performance of performing the cryptographic operation in the target operation on the cryptography database, and further improve performance of the cryptography database.

In the above described embodiments, each unit or module can be implemented by hardware, software, or any combination thereof. When the unit or module is implemented by software, the software can be stored in a computer-readable medium or transmitted as one or more instructions to implement corresponding functions.

It should be understood that the above descriptions are merely example embodiments of this disclosure, but are not intended to limit the protection scope of this disclosure. Any modification, equivalent replacement, improvement, or the like made based on the embodiments of this disclosure shall fall within the protection scope of this disclosure.

What is claimed is:

1. A data processing method for an encrypted database, wherein the method is performed by a heterogeneous processing platform including a first computing unit implemented by a general processing unit and a second computing unit implemented by a dedicated acceleration unit, and the method comprises:
obtaining, by the first computing unit, a ciphertext parameter and a database instruction from a user end device, wherein the database instruction instructs to perform a target operation on the encrypted database;
converting, by the first computing unit, the database instruction into a computing instruction to be executed by the second computing unit, and transmitting the computing instruction to the second computing unit;
performing, by the second computing unit according to the computing instruction, a cryptographic operation corresponding to the target operation on ciphertext data in the encrypted database and the ciphertext parameter, to obtain a ciphertext result; and
transmitting, by the second computing unit, the ciphertext result to the first computing unit.

2. The method according to claim 1, wherein before the performing, by the second computing unit according to the computing instruction, the cryptographic operation corresponding to the target operation on ciphertext data in the encrypted database and the ciphertext parameter, the method further comprises:
reading, by the first computing unit, the ciphertext data from the encrypted database based on the database instruction, and transmitting the ciphertext data and the ciphertext parameter to the second computing unit.

3. The method according to claim 1, wherein before the performing, by the second computing unit according to the computing instruction, the cryptographic operation corresponding to the target operation on the ciphertext data in the encrypted database and the ciphertext parameter, the method further comprises:
transmitting, by the first computing unit, a read instruction determined based on the database instruction to the second computing unit; and
reading, by the second computing unit, the ciphertext data from the encrypted database according to the read instruction.

4. The method according to claim 1, wherein after the transmitting, by the second computing unit, the ciphertext result to the first computing unit, the method further comprises:
storing, by the first computing unit, the ciphertext result in the encrypted database; or
sending, by the first computing unit, the ciphertext result to the user end device.

5. The method according to claim 1, wherein the first computing unit is a central processing unit (CPU), and the second computing unit is at least one of a graphics processing unit (GPU), a field programmable gate array (FPGA), or an application-specific integrated circuit (ASIC).

6. The method according to claim 1, wherein the encrypted database is a homomorphically encrypted database, and the cryptographic operation is a homomorphic operation.

7. The method according to claim 1, wherein the user end device has a public key and a corresponding private key, the ciphertext parameter is obtained after a user parameter is encrypted by using the public key, and the private key is used to decrypt the ciphertext result.

8. The method according to claim 7, further comprising:
obtaining, by the first computing unit, an auxiliary key from the user end device, and transmitting the auxiliary key to the second computing unit; and
performing, by the second computing unit, the cryptographic operation based on the auxiliary key.

9. The method according to claim 6, wherein the second computing unit is a graphics processing unit (GPU) or an AI accelerator chip that is applicable for a matrix operation, the cryptographic operation comprises a fully homomorphic encryption operation implemented based on a fast number-theoretic transform (NTT), and the NTT is implemented by using the matrix operation.

10. The method according to claim 1, wherein the first computing unit is a central processing unit (CPU), and the second computing unit is a graphics processing unit (GPU); and
the performing, by the second computing unit according to the computing instruction, a cryptographic operation corresponding to the target operation on ciphertext data in the encrypted database and the ciphertext parameter comprises:
storing, by the second computing unit, the ciphertext data and the ciphertext parameter in a graphics memory based on the computing instruction; and
reading, by the second computing unit, the ciphertext data and the ciphertext parameter from the graphics memory, to perform the cryptographic operation to obtain the ciphertext result.

11. A data processing system for an encrypted database, comprising:
at least one processor; and
at least one memory storing instructions executable by the at least one processor,
wherein the at least one processor comprises a first computing unit implemented by a general processing unit and a second computing unit implemented by a dedicated acceleration unit, and is configured to:
obtain, by the first computing unit, a ciphertext parameter and a database instruction from a user end device, wherein the database instruction instructs to perform a target operation on the encrypted database;
convert, by the first computing unit, the database instruction into a computing instruction to be executed by the second computing unit, and transmit the computing instruction to the second computing unit;
perform, by the second computing unit according to the computing instruction, a cryptographic operation corresponding to the target operation on ciphertext data in the encrypted database and the ciphertext parameter, to obtain a ciphertext result; and
transmit, by the second computing unit, the ciphertext result to the first computing unit.

12. The system according to claim 11, wherein before performing, by the second computing unit according to the computing instruction, the cryptographic operation corresponding to the target operation on ciphertext data in the encrypted database and the ciphertext parameter, the at least one processor is further configured to:
read, by the first computing unit, the ciphertext data from the encrypted database based on the database instruction, and transmit the ciphertext data and the ciphertext parameter to the second computing unit.

13. The system according to claim 11, wherein before performing, by the second computing unit according to the computing instruction, the cryptographic operation corresponding to the target operation on the ciphertext data in the encrypted database and the ciphertext parameter, the at least one processor is further configured to:
transmit, by the first computing unit, a read instruction determined based on the database instruction to the second computing unit; and
read, by the second computing unit, the ciphertext data from the encrypted database according to the read instruction.

14. The system according to claim 11, wherein after transmitting, by the second computing unit, the ciphertext result to the first computing unit, the at least one processor is further configured to:
store, by the first computing unit, the ciphertext result in the encrypted database; or
send, by the first computing unit, the ciphertext result to the user end device.

15. The system according to claim 11, wherein the first computing unit is a central processing unit (CPU), and the second computing unit is at least one of a graphics processing unit (GPU), a field programmable gate array (FPGA), or an application-specific integrated circuit (ASIC).

16. The system according to claim 11, wherein the encrypted database is a homomorphically encrypted database, and the cryptographic operation is a homomorphic operation.

17. The system according to claim 11, wherein the user end device has a public key and a corresponding private key, the ciphertext parameter is obtained after a user parameter is encrypted by using the public key, and the private key is used to decrypt the ciphertext result.

18. The system according to claim 17, wherein the at least one processor is further configured to:
obtain, by the first computing unit, an auxiliary key from the user end device, and transmit the auxiliary key to the second computing unit; and
perform, by the second computing unit, the cryptographic operation based on the auxiliary key.

19. The system according to claim 16, wherein the second computing unit is a graphics processing unit (GPU) or an AI accelerator chip that is applicable for a matrix operation, the cryptographic operation comprises a fully homomorphic encryption operation implemented based on a fast number-theoretic transform (NTT), and the NTT is implemented by using the matrix operation.

20. The system according to claim 11, wherein the first computing unit is a central processing unit (CPU), and the second computing unit is a graphics processing unit (GPU); and
the at least one processor is further configured to:
store, by the second computing unit, the ciphertext data and the ciphertext parameter in a graphics memory based on the computing instruction; and
read, by the second computing unit, the ciphertext data and the ciphertext parameter from the graphics memory, to perform the cryptographic operation to obtain the ciphertext result.
